(19) United States
(12) Patent Application Publication
(10) Pub. No.: US 2005/0199542 A1
(43) Pub. Date: Sep. 15, 2005

(54) Acid reducing filter

(76) Inventors: Jason P. Snider, Olney, IL (US); Brent L. Birch, Olney, IL (US)

Correspondence Address: Olson & Hierl, Ltd., 36th Floor, 20 N. Wacker Drive, Chicago, IL, 60606, US

(21) Appl. No.: 10/799,092

(22) Filed: Mar. 12, 2004

(51) Int. Cl. B01D 35/00

(52) U.S. Cl. 210/443; 210/493.1; 210/501; 210/493.5

(57) ABSTRACT

A fluid filter comprising a shell having an open end and an end plate closing the open end of the shell. The end plate has inlet openings and outlet openings therethrough. Disposed in the shell is a filter media. The filter media comprises an annular multi-layered member having at least two layers copleated together. The outer layer comprises a metal that sacrificially neutralizes the corrosive products in the fluid, and the inner layer comprises a cellulosic or synthetic material. The metal is preferably zinc. In use the fluid will enter the shell via the inlet openings, pass through the filter media and exit the shell from the outlet opening means. The zinc will neutralize the acidity of the oil caused 1) by the sulfur compounds that react with the moisture in the oil to form an acidic solution and 2) carbon particles resulting from incomplete combustion in the engine and thereby protect the engine and increase the life of the oil allowing for extended drain and oil change intervals.

### BACKGROUND OF THE INVENTION

The present invention pertains to a filter for reducing the acidity of engine oil caused by 1) the sulphur compounds that react with the moisture from combustion to form an acidic solution and 2) by carbon particles or soot resulting from incomplete combustion in the engine, and more particularly, to a filter having a multi layer filter media containing a layer of material for neutralizing the acid and protecting the engine and increasing the life of the oil and extend drain intervals.

New oil is generally clear and light in color. It contains no sulfur. During a normal compression stroke in an engine, a small amount of gases in the combustion chamber escape past the pistons or blow-by the piston rings and cause fuel, air and moisture to be forced past the piston rings into the crankcase. Approximately 70 per cent of these blow-by gases are unburned fuel (HC) that can dilute and contaminate the engine oil, cause corrosion to critical parts, and contribute to sludge buildup. As the piston rings and cylinder liners wear away in use they are less capable of maintaining the desired seal and the amount of blow-by can increase. Soot and deposits left over from incomplete combustion that collect on the piston rings can also inhibit their seal, thus worsening blow-by. Further, residual fuel, for example, diesel fuel on the walls of the cylinders, can drain into the crankcase.

When the fuel, air, and moisture slip into the crankcase they contaminate and dilute the oil in the crankcase. Sulfur from the fuel can react with the moisture to form sulfuric acid in the oil. The amount of sulfur in the fuel can vary. This is because some crude oils are naturally high in sulfur. It is difficult and expensive to remove the sulfur as the diesel fuel is produced from the crude oil, so the sulfur remains in the diesel fuel. When the fuel is burned in the engine, the sulfur is also burned, forming sulfur oxides. Most of the sulfur oxides will go out the exhaust. Some will get into the engine crankcase with the exhaust blow-by and combine with moisture to form sulfur acids.

The prior art has tried to solve the problem of acid in the oil by modulating the Total Base Number (TBN) through additives in the oil and by supplementing these additives by placing strong bases into the filters. The TBN value of an oil is calculated from the amount of acid that is required to counteract its basic characteristics. The TBN is expressed as the Equivalent mass in milligrams (mg) of potassium hydroxide (KOH) per gram of the oil. Paul U.S. Pat. No. 4,075,097 utilized a slow dissolving thermoplastic which contained various chemicals depending upon the application. These chemicals were supplements to the additive package already contained in the filter. Rohrbach U.S. Pat. No. 6,379,564 utilized the same type of chemicals, as well as an assortment of strong bases, but packaged it in a non-woven fiber. The delivery method required the additives to be contained in the core of the fibers and as the oil passed through the chemically active part of the filter, the fibers dissolved, releasing the chemical and sustaining the life of the oil.

### SUMMARY OF THE INVENTION

Vehicle operators, particularly, heavy truck and heavy equipment operators, desire to extend oil drain intervals and to counter the adverse effects of exhaust gas recirculation (EGR) and lower temperature combustion that tend to undesirably increase the acidity of the oil. The present invention provides a novel co-pleated filter media including a zinc layer. The use of zinc serves to protect the engine and the oil from acid produced by the combustion products and by sulfur in the oil reacting with water in the oil to form sulfuric acid. The use of the co-pleated filter media packs relatively large amounts of zinc within the filter and provides a large surface area of active material to increase the active material capable of interacting with the oil passing through the filter.

An object of the present invention is to provide a filter containing a novel filter media incorporating a layer of zinc co-pleated with a layer of cellulose or synthetic material for increasing the life of the oil passing through the filter and for increasing the life of the engine with which the filter is used.

Another object of the present invention is to provide an oil filter having a multi-layer pleated filter media for packing large amounts of a pH control metal into the filter media to help maintain the pH of the oil passing through the filter.

Yet another object of the present invention is to provide a filter containing an annular multi-layer filter media including a thin outer layer of zinc for reacting with the oil passing through the filter media and producing a neutral pH product to help maintain the pH of the oil.

Other objects and advantages of the present invention will become more apparent hereinafter.

### BRIEF DESCRIPTION OF THE DRAWING

There is shown in the attached drawing a presently preferred embodiment of the present invention, wherein like numerals in the various views refer to like elements, and wherein:

FIG. 1 is a vertical cross-section of a filter embodying the filter media of the present invention, the filter being mounted on a manifold;

FIG. 2 is a transverse cross-section of the filter, taken generally along the line 2-2 of FIG. 1;

FIG. 3 is a detail view of the filter media taken in the region 3 of FIG. 2;

FIG. 4 is a side view of the filter media taken generally along the line 4-4 of FIG. 3;

FIG. 5 is a perspective view of the outer layer of the filter media of the present invention.

FIG. 6 is a detail section view of the layer of zinc taken through a slit; and

FIG. 7 is a detail section view of a layer of zinc taken through a stepped but unslit portion.

### DETAILED DESCRIPTION OF THE INVENTION

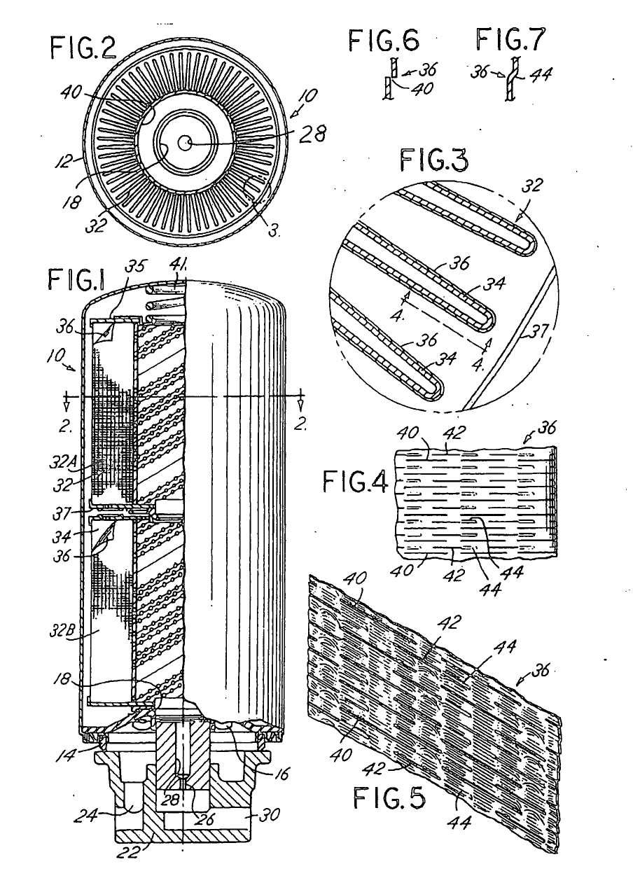

There is shown in FIG. 1 a cross-sectional view of a filter 10 that includes the novel filter media of the present invention. The filter 10 includes a shell or housing 12 that is closed at the top, as viewed in FIG. 1, and is open at the bottom, as viewed in FIG. 1. The bottom of the shell 12 is closed by an end plate 14 in a conventional manner. The end plate 14 has a plurality of inlet openings 16 and a central outlet opening 18 that is internally threaded. The central outlet opening 18 is adapted to receive the top of the cored stud 20 that is secured to the manifold 22.

The manifold 22 is formed with an inlet passage 24 that communicates with the inlet openings 16 in the end plate 14. The stud 20 has an orifice 26 in the opening 28. Fluid flow from the orifice 26 will flow through the outlet passage 30 and be returned to the engine (not shown).

Confined within the shell 12 is the filter media 32 of the present invention. The filter media comprises multi layers of material bonded at each end to end caps 35, 37. The base layer 34 is essentially a pleated cellulose material. In some applications a synthetic material, such as, polyester and fiber glass, could be used. The outer layer 36 is essentially a pleated material having the property of reacting with the oil passing therethrough to produce a neutral pH product.

The presently preferred material is a thin zinc layer on the order of 0.003 plus or minus 0.001 inch thick. Another material that might be used in place of the zinc is magnesium, though it will be apparent to persons skilled in the art that other materials having the desired property of reacting with the oil to neutralize the acid therein may be employed.

A core 40 comprised of a thin perforated or louvered steel material may be provided in the center of the filter media 32. A spring 41 is disposed between the inner surface of the shell 12 and the top end cap 35 to urge the filter media downwardly into engagement with the end plate 14. The filter media 32 may comprise a single member or it may be comprised of a pair of stacked members 32A and 32B as shown in FIG. 1. An annular seal 42 may be provided between the bottom of the upper filter media 32A and the top of the lower filter media 34B to assure that fluid passing from the bottom of the opening through the upper filter media 32A will pass into the top of the opening in the lower filter media 32B.

The filter media 32 can be fabricated by aligning the perforated sheet of zinc on the cellulose material and then co-pleating the two layers to form the filter media. If desired, an adhesive can be applied to the cellulose layer or the zinc layer to help better fix the zinc layer to the cellulose layer prior to pleating. The two layers are pleated after they are aligned and/or bonded together to form the co-pleated filter media.

FIGS. 2 and 3 better show the annular, multi-layer filter media 32. In the preferred embodiment the zinc layer 36 is the outer layer of the filter media 32 and is co-pleated with the inner layer 34. It is the outer layer of the filter media that first comes into contact with the oil passing through the filter 10.

Turning to FIGS. 4 and 5, there is better shown the layer 36, which comprises a thin sheet of metal, in a presently preferred embodiment zinc, for interacting with the oil passing through the filter 10 and maintaining the pH of the oil so as to enhance the life of the oil. The zinc sheet 36 is in one present embodiment on the order of 0.003 inch thick. For cost purposes, it is desired that the sheet of zinc be as thin as possible. However, it must be thick enough to provide sufficient strength to maintain its form in use. The sheet 36 can be smooth on each side and provided with suitable slits or openings to pass oil through the filter media. However, as shown, the surfaces of the sheet 36 are roughened or waffled so as to maximize the surface exposed to the oil. The roughening or waffling is accomplished by providing a row of slits 40 of a predetermined length and a row of slits 42 of a shorter predetermined length. The region 44 to the right of the each slit 42 is stepped, but is not slit. The slits or openings are of sufficient size and number to permit the desired flow of oil through the filter media in use. Because of the stepping of the material of the sheet and the nature of the slitting to form the openings, the openings can be regarded to have the form of a louver. The stepping provides some rigidity for the sheet.

There are shown in FIGS. 6 and 7 details of the sheet 36. In FIG. 6 there is shown a cross-section of the sheet showing a slit 40 (or 42). It will be understood that the slits 40 and 42 have essentially the same configuration, namely, narrow elongated openings. In FIG. 7 there is shown a cross section of the sheet 36 in the region 44 showing that this region is stepped, but is not slit.

In operation, oil will enter the inlet passage 24 in the manifold 22 and pass through the inlet openings 16 into the shell 12 between the side wall of the shell and the exterior of the filter media 32. Oil then flows through the openings or slits 40, 42 in the zinc layer 36 of the filter media, through the cellulose layer 34, through the openings in the core 40, through the central outlet opening 18 in the end plate 14 into the opening 28 in the stud, through the orifice 26 and into the outlet passage 30 in the manifold 22 for return to the engine. In one present embodiment the filter 10 can handle about 1.5 gallons per minute of oil flow.

Presently, users often employ the following factors to determine oil change intervals. First, most oils generally have a TBN between 6-10 when new. When the TBN drops below 2, the oil and filter should be changed. For high TBN oils, oil and filter should be changed when the TBN falls below one-half of the new value. Second, when the soot concentration is greater than 4% the oil and filter should be changed. The filter of the present invention addresses these two oil change triggering mechanisms.

While it is preferred that the zinc comprise the outer layer of the filter media, since this arrangement will more likely preclude zinc particles from passing through the filter media, it would be possible to utilize the zinc layer on the inside of the cellulose layer, recognizing the possibility of some zinc particles being better able to get through the filter 10 into the engine. A further possible alternative would be to use a zinc layer on both sides of the cellulosic or synthetic layer.

The zinc acts as a sacrificial material to maintain the pH of the oil so as to increase the life of the oil and the life of the engine through which it flows. The co-pleating process and the use of the thin zinc sheet allows for large amounts of zinc to be put in the filter media, giving more benefit to the oil. There is no carrier for the chemical to be dispersed through the oil. Rather than supplementing the oil by adding more of the existing additive package back into the oil, the zinc protects the already existing additive package, therefore increasing the life of the oil.

As noted above, undesirable acid increase in diesel oil comes from two main sources. First, from soot or carbon particles in the diesel oil resulting from incomplete combustion due to engine compliance for heavy trucks with diesel engines and second, from sulfur in the diesel oil that reacts with water to form sulfuric acid. The zinc in the filter media in the filter acts to reduce the acidity of the diesel oil in use from both sources.

While we have shown a presently preferred embodiment of the present invention, it will be understood that the invention may be otherwise embodied within the scope of the following claims.

1. A fluid filter comprising a shell having an open end, an end plate closing the open end of the shell, the end plate having inlet opening means and outlet opening means, a filter media retained in the shell, the filter media comprising an annular co-pleated member having at least two layers, the outer layer comprising a metal that sacrificially neutralizes the corrosive products in the fluid, whereby, in use the fluid will enter the shell via the inlet opening means, pass through the filter media and exit the shell from the outlet opening means.

2. A fluid filter as in claim 1 wherein the metal in the outer layer is zinc.

3. A fluid filter as in claim 2 wherein the inner layer is comprised of a cellulose material.

4. A fluid filter comprising a shell having an open end, an end plate closing the open end of the shell, the end plate having inlet opening means and outlet opening means, a filter media retained in the shell, the filter media comprising an annular co-pleated member having at least two layers, one layer comprising a material that sacrificially neutralizes the corrosive products in the fluid, and the other layer comprising a cellulose material, whereby, in use the fluid will enter the shell via the inlet opening means, pass through the filter media and exits the shell from the outlet opening means.

5. A fluid filter as in claim 4, wherein the fluid is oil and the said one layer is zinc.

6. A fluid filter as in claim 5 wherein the said one layer is perforated to permit oil to pass there through.

7. A fluid filter as in claim 6, wherein the perforations are in the form of slits.

8. A fluid filter as in claim 6, wherein the perforations are in the form of louvers.

9. A fluid filter comprising a shell having an open end, an end plate closing the open end of the shell, the end plate having inlet opening means and outlet opening means, a filter media retained in the shell, the filter media comprising an annular multi-layer member having at least two layers, the outer layer comprising a metal that sacrificially neutralizes the corrosive products in the fluid, whereby, in use the fluid will enter the shell via the inlet opening means, pass through the filter media and exit the shell from the outlet opening means.

10. A fluid filter as in claim 9 wherein the metal in the outer layer is zinc.

11. A fluid filter as in claim 10 wherein the inner layer is comprised of a cellulose material.

12. A fluid filter as in claim 10 wherein the inner layer is comprised of a synthetic material.

13. A fluid filter as in claim 9 wherein the outer layer and the inner layer are co-pleated.

14. A fluid filter comprising a shell having an open end, an end plate closing the open end of the shell, the end plate having inlet opening means and outlet opening means, a filter media retained in the shell, the filter media comprising an annular multi-layer member having three layers, the outer layer and the inner layer each comprising a metal that sacrificially neutralizes the corrosive products in the fluid, whereby, in use the fluid will enter the shell via the inlet opening means, pass through the filter media and exit the shell from the outlet opening means.

15. A fluid filter as in claim 14 wherein the middle layer is comprised of a cellulosic material.

16. A fluid filter as in claim 14 wherein the middle layer is comprised of a synthetic material.
